(19) United States
(12) Patent Application Publication
(10) Pub. No.: US 2026/0184056 A1
(43) Pub. Date: Jul. 2, 2026

(54) METHOD OF CO-CURING A SANDWICH STRUCTURE

(71) Applicant: Lockheed Martin Corporation, Bethesda, MD (US)

(72) Inventors: Felix Nhanchau Nguyen, Parker, CO (US); Tracy Bradford Colwell, Sunnyvale, CA (US); Cecilia L. Wilson, Bethesda, MD (US); Marie D. Flanigan, Bethesda, MD (US)

(73) Assignee: Lockheed Martin Corporation, Bethesda, MD (US)

(21) Appl. No.: 19/007,150

(22) Filed: Dec. 31, 2024

(51) Int. Cl. B32B 37/06; B32B 37/12; B32B 38/00

(52) U.S. Cl. CPC B32B 37/06; B32B 37/12; B32B 38/00; B32B 2037/1253; B32B 2038/0076

(57) ABSTRACT

Methods of co-curing a sandwich structure are disclosed. In some embodiments, methods includes providing a sandwich structure comprising, in order, a first facesheet component; a first adhesive component; a core component; a second adhesive component; and a second facesheet component; curing the first and second facesheet components to a first facesheet degree of cure (DOC) and curing the first and second adhesive components to a first adhesive DOC, wherein the first facesheet DOC and the first adhesive DOC being a partially cured states, and wherein the first facesheet DOC is unequal to the first adhesive DOC; and curing the partially cured first and second facesheet components to a second facesheet DOC and curing the partially cured first and second adhesive components to a second adhesive DOC, wherein the second facesheet DOC being greater than the first facesheet DOC and the second adhesive DOC being greater than the first adhesive DOC.

### FIELD OF THE DISCLOSURE

The present disclosure is related to a method of co-curing a sandwich structure.

### BACKGROUND OF THE DISCLOSURE

The use of sandwich structures, such as a composite sandwich panel, is becoming more prevalent in aerospace applications as the demands for weight reduction increase and stiffness requirements increase. Generally, the sandwich structure includes a facesheet and a core material assembled and bonded together using adhesive components. During curing of the sandwich structure, resin from the facesheet and/or the adhesive can bleed into the core material compromising quality of the sandwich structure. Some conventional curing processes solve this problem by introducing a barrier layer between the core material and the facesheet of the sandwich structure to prevent resin bleed during the curing process. However, this solution increase weight and manufacturing time of the sandwich structure. For example, the barrier layer and a portion of the sandwich structure are each cured, assembled with remaining uncured portions of the sandwich structure and then further cured.

To minimize manufacturing time, it is desirable to co-cure the sandwich structure whereby all the parts (e.g., facesheet, adhesive, core) are assembled and cured in a single operation. One of the challenges of co-curing is above-mentioned resin bleed into the core material which can reduce facesheet to core bonding and compromise quality of the sandwich structure. Another challenged is fiber waviness in plies of the facesheet components that are pressed against the core material by applied pressure during the curing process, for example, using an autoclave or similar cure equipment. FIG. 1 depicts a schematic view of ply waviness in accordance with embodiments of the present disclosure. A partial sandwich structure having a facesheet component 10, an adhesive component 20, and a core 30 cured using heat and pressure may have ply waviness due to imprints of one of more plies of the facesheet component against the core under heat and pressure during curing. As a result of the one of more plies imprinting on the core, the adhesive component, a portion of the facesheet component, and a portion of the core material create waves as depicted in FIG. 1.

There is a need in the art for improved methods of co-curing sandwich structures.

### BRIEF SUMMARY OF DISCLOSURE

Methods of co-curing a sandwich structure are disclosed herein. In some embodiments, a method includes providing a sandwich structure comprising, in order, a first facesheet component; a first adhesive component; a core component; a second adhesive component; and a second facesheet component; curing the first and second facesheet components to a first facesheet degree of cure (DOC) and curing the first and second adhesive components to a first adhesive DOC, wherein the first facesheet DOC and the first adhesive DOC being a partially cured states, and wherein the first facesheet DOC is unequal to the first adhesive DOC; and curing the partially cured first and second facesheet components to a second facesheet DOC and curing the partially cured first and second adhesive components to a second adhesive DOC, wherein the second facesheet DOC being greater than the first facesheet DOC and the second adhesive DOC being greater than the first adhesive DOC.

In some embodiments, a sandwich structure, comprising, in order, a first facesheet component; a first adhesive component; a core component; a second adhesive component; and a second facesheet component, wherein each of the first and second facesheet components is curable at an inequal rate to each of the first and the second adhesive components.

### BRIEF SUMMARY OF DRAWINGS

To assist in understanding the present disclosure, reference is now made to the following description taken in conjunction with the accompanying drawings, in which:

FIG. 1 depicts a schematic view of ply waviness in accordance with embodiments of the present disclosure.

FIG. 2 depicts a schematic view of a sandwich structure in accordance with some embodiments of the present disclosure.

FIG. 3A depicts a schematic view of a facesheet component of a sandwich structure in accordance with some embodiments of the disclosure.

FIG. 3B depicts a schematic view of a ply of a facesheet component in accordance with some embodiments of the disclosure.

FIG. 3C depicts a schematic view of a ply of a facesheet component in accordance with some embodiments of the disclosure.

FIG. 4A depicts a schematic view of adhesive component in accordance with some embodiments of the disclosure.

FIG. 4B depicts a schematic view of adhesive component in accordance with some embodiments of the disclosure.

FIG. 5 depicts a flow chart of a method for forming a sandwich structure in accordance with some embodiments of the disclosure.

FIG. 6 depicts a schematic temperature profile and corresponding material state of the sandwich structure in accordance with some embodiments of the disclosure.

FIG. 7 depicts a schematic view of temperature profiles to obtain a material state in accordance with some embodiments of the disclosure.

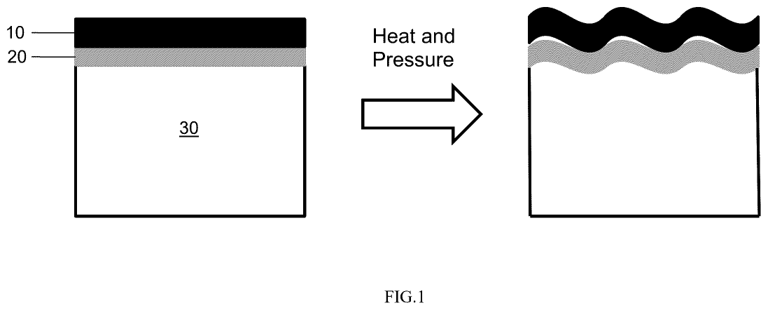

### DESCRIPTION

Methods of forming a co-cured sandwich structure are disclosed herein. The method produces the sandwich structure at reduced time and/or cost. The method reduces and/or prevents resin bleed in a core material of the sandwich structure during curing and further reduces and/or prevents waviness in plies of the facesheet that can occur during co-curing. In some embodiments, the method utilizes accelerated curing in portions of plies in the facesheet components relative to adhesive components to cause resin of the portions of plies to gel at a higher rate which can minimize waviness in the plies and resin bleed into the core material. In some embodiments, the method utilizes an adhesive component to promote a faster cure rate than resin of the portion of plies, which cause the adhesive material to gel at higher rate and become a barrier layer that can minimize waviness in the plies and resin bleed into the core material. Material selections, sandwich structures, and corresponding cure methods are described herein.

It should be understood at the outset that, although example implementations of embodiments of the disclosure are illustrated below, the present disclosure may be implemented using any number of techniques, whether currently known or not. The present disclosure should in no way be limited to the example implementations, drawings, and techniques illustrated below. Additionally, the drawings are not necessarily drawn to scale.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both structure and several, unless expressly indicated otherwise or indicated otherwise by context. Therefore, herein, “A and B” means “A and B, structurally or severally,” unless expressly indicated otherwise or indicated otherwise by context.

The use of the terms “a” and “an” and “the” and similar referents in the context of describing the invention (especially in the context of the following statements) are to be construed to cover both the singular and the plural, unless otherwise indicated herein or clearly contradicted by context. As used in this document, “each” refers to each member of a set or each member of a subset of a set. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. Moreover, recitation of a range such as “of A to B”, or “from A to B”, or “between A to B”, or any recitation of range is intended to include the endpoints A and B. The use of any and all examples, or exemplary language (e.g., “such as”) provided herein, is intended merely to better explain the disclosure and does not pose a limitation on the scope of statements.

The use of terms ‘overlying’, ‘underlying’, ‘disposed on’ and similar referents in the context of the present disclosure are to be construed to cover both being separated and in direct contact with an adjacent structure. For example, a first layer ‘overlying’ or ‘disposed on’ a second layer means the first layer is above the second layer, where the first layer may be separated from the second layer by one or more intervening layers or the first layer may be in direct contact with the second layer. The terms ‘overlying’, ‘underlying’, ‘disposed’ are not intended to be construed to exclusively mean ‘in direct contact with’ an adjacent structure.

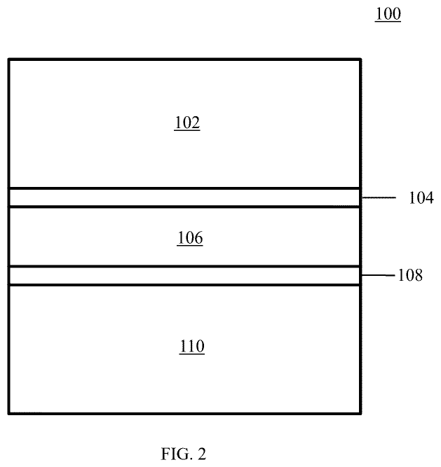

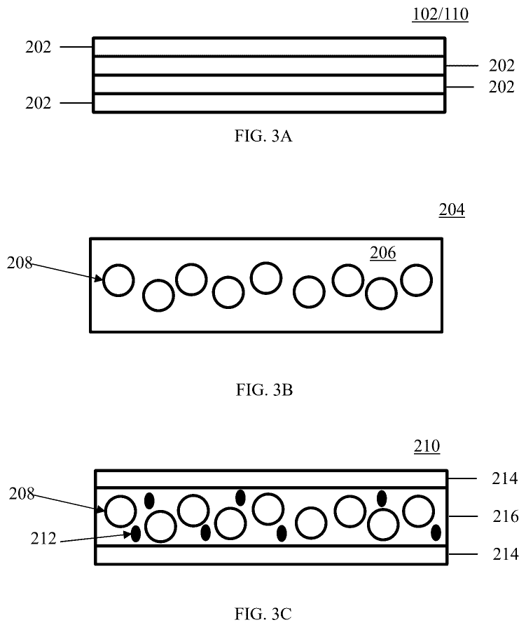

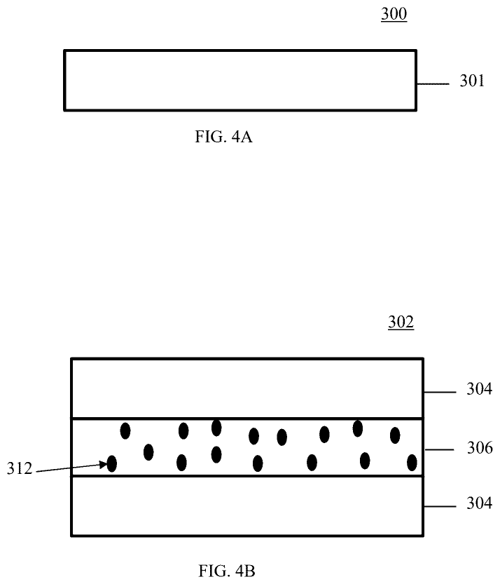

FIG. 2 depicts a schematic view of a sandwich structure 100 in accordance with some embodiments of the present disclosure. The sandwich structure 100 comprises, in order, a first facesheet component 102, a first adhesive component 104, a core component 106, a second adhesive component 108, and a second facesheet component 110. At least one of the first and second facesheet components 102, 110, or the first and second adhesive components 104, 108, has a first region and a second region, where the second region includes a cure accelerating agent absent from the first region (discussed below in reference to FIGS. 3C and 4B).

Exemplary sandwich structures may include airframe components, spacecraft panels, space bus structures, payload adaptors, buckling critical components, compression-driven components, fairings, edges, blades, and other suitable aerospace, defense and space components. The sandwich structure 100 may have an overall thickness ranging from about 0.25 inch to about 10 inches. In some embodiments, the overall thickness may range from about 0.5 inch to about 5 inches. In some embodiments, the overall thickness may range from about 1 inch to about 3 inches. The sandwich structure 100 may have overall lengths, widths, and/or diameters ranging from about 1 foot to about 100 feet, about 3 ft to about 30 ft, or about 2 ft to about 10 ft. The sandwich structure may have an overall footprint ranging from about 2 square feet to about 500 square feet, about 2 square feet to about 100 square feet, or about 5 square feet to about 50 square feet.

The first and second facesheet components 102, 110 may be the same or different. For example, the first and second facesheet components 102, 110 may include the same or different materials, may include the same or different shapes and/or dimensions, may include the same materials in different shapes and/or dimensions, and the like. The first and second facesheet components 102, 110 may each have an overall thickness ranging from about 0.01 inch to about 5 inches, about 0.02 inch to about 1 inch, or about 0.03 inch to about 0.5 inch. The first and second facesheet components 102, 110 may each have overall lengths, widths, and/or diameters ranging from about 1 foot to about 100 feet, about 3 ft to about 30 ft, or about 2 ft to about 10 ft. The first and second facesheet components 102, 110 may each have overall footprints ranging from about 2 square feet to about 500 square feet, about 2 square feet to about 100 square feet, about 5 square feet to about 50 square feet.

Referring to FIG. 3A, the first and second facesheet components 102, 110 may comprise a plurality of plies 202. Each ply 202 may range, in cured ply thickness (CPT), from about 0.001 inches to about 0.02 inches. Each ply 202 may range in surface area from about 10 sq. in. to about 500 sq. ft. The first and second facesheet components 102, 110 can be formed of any suitable number of plies 202 to achieve a desired thickness, and/or structural characteristic. In some embodiments, a number of plies may range about 2 plies to 500 plies. In some embodiments, the number of plies may be more than 500 plies to achieve up to 5 inches thick of the facesheet component.

The plies 202 may be a composite material. FIG. 3B depicts an exemplary ply 204 that is

a composite material may include a resin composition 206 and one or more structural members 208. In some embodiments, the one or more structural members 208 maybe impregnated and/or embedded in the resin composition 206. Though depicted in FIG. 3B as being impregnated and/or embedded in the resin composition 206 on both sides thereof, in some embodiments the one or more structural members 208 may be impregnated and/or embedded on one side thereof (not shown). The one or more structural members 208 may be present in each ply in an amount of at least 30 vol %, at least 35 vol %, at least 40 vol %, at least 45 vol %, at least 50 vol %, at least 55 vol % to less than 60 vol %, less than 65 vol %, less than 70 vol %, less than 75 vol %, less than 80 vol %, or less than 85 vol %.

The plies 202 may include a first region and second region, the second region being curable at a different rate that the first region. FIG. 3C depicts an exemplary ply 210 that is a composite material including the resin composition 206, the one or more structural members 208 and an accelerator, such as a cure accelerating agent 212. The ply 210 includes first regions 214 and a second region 216 therebetween the first regions 214. The first regions 214 include outer surfaces of the ply 210. The first regions 214 may surround and/or encompass the second region 216 in some embodiments. Alternatively, the first and second regions 214, 216 may be in a multilayered configuration where a layer of the second region 216 is disposed between layers of the first region 214. The first region 214 may have a thickness ranging from 1 to 500 microns, or at most 200 microns. The second region 216 may have a thickness ranging from 0.01 to 10 mm or at most 2 mm. In some embodiments, the first regions 214 might not be distinguishable from the second region 216 in the resulting ply 210 (e.g., after heating and curing to a final cure state), where the resin compositions from the first and second region are intermixed during manufacturing and processing under heat and pressure.

The first regions 214 include the resin composition 206 and excludes, or substantially excludes, the one or more structural members 208 and the cure accelerating agent 212. The second region 216 includes the resin 206, the one or more structural members 208, and the cure accelerating agent 212. The one or more structural members 208 may be present in the second region in an amount of at least 30 vol %, at least 35 vol %, at least 40 vol %, at least 45 vol %, at least 50 vol %, at least 55 vol % to less than 60 vol %, less than 65 vol %, less than 70 vol %, less than 75 vol %, less than 80 vol %, or less than 85 vol %. The cure accelerating agent 212 may be present in the second region in an amount of at most 30 part by weight per 100 parts by weight of total resin amount (30 phr). The amount of cure accelerating agent may be adjusted to achieve a desired cure rate or degree of cure (DoC) in the second region 216 relative to the first region 214. A difference between DoC of the second region to that of the first region may be at least 1% or at least 3% at a given temperature over a period of time. In some embodiments, the resin composition in the first and second regions might be different in composition.

The resin composition 206 may include a thermoset resin.

Thermoset resins may be any resin which can be cured with a curing agent or a cross-linker compound by means of an externally supplied source of energy, such as heat, light, electron beam, or other suitable methods to form a three-dimensional crosslinked network having the required resin modulus. Light energy may include electromagnetic radiation in the microwave and/or ultraviolet wavelength range. Suitable thermoset resins include, but are not limited to, epoxy resins, epoxy novolac resins, ester resins, vinyl ester resins, cyanate ester resins, maleimide resins, bismaleimide (BMI) resins, bismaleimide-triazine resins, phenolic resins, novolac resins, resorcinolic resins, unsaturated polyester resins, diallylphthalate resins, urea resins, melamine resins, benzoxazine resins, polyimide resins, polyurethanes, their derivatives, or mixtures thereof. In some embodiments, the thermoset resin is a commercial polymer or an oligomer having a lower molecular weight than a commercial polymer.

In some embodiments, the resin composition can be included in the plies with one or more of a curing agent, a crosslinking agent or a hardener. The hardener may be used in a stoichiometric or non-stoichiometric ration relative to a resin. In some embodiments, the hardener may be included in an amount to completely crosslink with a corresponding thermoset resin, i.e., a stoichiometric ratio between the thermoset resin equivalent weight and the hardener equivalent weight. In some embodiments, the hardener may be included in an amount different from a stoichiometric ratio or up to about 75 parts by weight per 100 parts by weight of total thermoset resin (75 phr).

Exemplary cure agents for a resin composition comprising an epoxy resin include, but are not limited to, polyamides, dicyandiamide [DICY], amidoamines (e.g., aromatic amidoamines such as aminobenzamides, aminobenzanilides, and aminobenzenesulfonamides), aromatic diamines (e.g., diaminodiphenylmethane, diaminodiphenylsulfone [DDS] such as Aradur® 9664-1 and Aradur® 9719-1 from Huntsman Advanced Materials), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophorone diamine), imidazole derivatives, guanidines such as tetramethylguanidine, anhydrides (e.g., methylhexahydrophthalic anhydride), hydrazides (e.g., adipic acid dihydrazides [ADH], isophthalic dihydrazides [IDH], sebacic acid dihydrazides [SDH], valine dihydrazides [VDH], carbodihydrazides [CDH], icosanedioic acid dihydrazides, phthalic dihydrazide, terephthalic dihydrazide, 1,2,3-benzenetricarboxic trihydrazide, benzoic acid hydrazide, aliphatic monohydrazides, aliphatic trihydrazides, aliphatic tetrahydrazides, and aromatic monohydrazides, aromatic dihydrazides, aromatic trihydrazides, aromatic tetrahydrazides, p-toluenesulfonylhydrazide, benzenesulifinic hydrazide, benzenesulfonyl hydrazide, sulfuryl hydrazide, and phosphoric acid trihydrazide, 2-aminobenzoic hydrazide or 4-aminobenzoic hydrazide), hydrazines (e.g., phenylhydrazine, naphthalene hydrazine, 1-hexylhydrazine, p-phenylenebis(hydrazine), 1,6-hexamethylene dihydrazine, and 1,2-diphenyl hydrazine), phenol-novolac resins and cresol-novolac resins, carboxylic acid amides, polyphenol compounds, polysulfides and mercaptans, and Lewis acids and bases (e.g., boron trifluoride ethylamine, tris-(diethylaminomethyl) phenol), their derivatives, or combinations thereof. In some embodiments, the resin composition may include an additive. In some embodiments, the resin composition comprises from 0.1% to 40% (w/w) of an additive, based on a total weight of the resin. In some embodiments, the resin composition includes at least 0.1% (w/w) of the additive, or at least 1%, at least 2%, at least 3%, at least 4%, or at least 5% to less than 10%, less than 11%, less than 12%, less than 13%, less than 14%, or less than 40% (w/w) of the additive, based on the total weight of the resin composition.

Exemplary additives include thermoplastics, fillers, or combinations thereof. Suitable fillers include, but are not limited to, interpenetration network polymers, elastomers, branched polymers, hyperbranched polymers, dendrimers, rubbery polymers, rubbery copolymers, block copolymers, core-shell particles, oxides or inorganic materials such as silica, clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization, or combinations thereof. Suitable thermoplastics include polyvinyl formals, polyamides, polycarbonates, polyacetals, polyphenyleneoxides, polyphenylene sulfides, polyarylates, polyesters, polyamideimides, polyimides, polyetherimides, polyimides having phenyltrimethylindane structure, polysulfones, polyethersulfones, polyetherketones, polyetheretherketones, polyaryletherketone, polyaramids, polyethernitriles, polybenzimidazoles, their derivatives or their mixtures thereof.

The one or more structural members 208 can include fibers and/or particles. In some embodiments, the one or more structural members 208 includes one or more fibers. The resin composition can be coated on and/or impregnated in the one or more structural members. The resin composition can be cured by the methods disclosed herein. The fibers can be in any suitable shape and/or form. Non-limiting and exemplary fibers can include carbon fibers, glass fibers, aramid fibers, graphite fibers, boron fibers, metal fibers, natural/bio fibers, other organic or inorganic fibers, or combinations thereof. The fibers can be arranged in any suitable configuration, such as unidirectional, biaxial, triaxial, quadaxial, randomly oriented, woven, non-woven, non-crimp, braided, bundled, matted, or the like.

The cure accelerating agent 212 can be any suitable agent that accelerates curing of a thermoset resin. Exemplary cure accelerating agents for a resin composition comprising an epoxy resin and a corresponding hardener, can include, but not limited to, urea compounds, sulfonate compounds, boron trifluoride piperidine, p-t-butylcatechol, sulfonate compounds, tertiary amines or salts thereof, imidazoles or salts thereof, phosphorus curing accelerators, metal carboxylates, Lewis or Bronsted acids or salts thereof, or combinations thereof.

The cure accelerating agent 212 is, preferably, included proximate the one or more structural members 208 and in the second region 216. The cure accelerating agent 212 is, preferably, excluded, or substantially excluded, from the first region 214 which is proximate the exterior of the ply 210. Excluding, or substantially excluding, the cure accelerating agent 212 from the first region 214 of the ply 210 can reduce and/or prevent resin cure advancement of the ply 210 under ambient conditions since the first regions absence the cure accelerating agent 212 might act as insulation layers. Excluding, or substantially excluding, the cure accelerating agent 212 from the first region 214 can prolong out time at least 7 days or at least 14 days and tack of the ply 210 at ambient conditions. During cure at an elevated temperature the cure accelerating agent 212 in the second region might start an exothermic reaction, thus accelerating curing of the ply 210.

Returning to FIG. 3A, the first and second facesheet components can include the plies 204, the plies 210, or a combination thereof. In some embodiments, the first and second facesheet components 102, 110 consist of plies 204. In some embodiments, the first and second facesheet components 102, 110 may include at least one ply 204 proximate the first and second adhesive components 104, 108, respectively. In some embodiments, the first and second facesheet components 102, 110 consist of plies 210. In some embodiments, the first and second facesheet components 102, 110 may include at least one ply 210 proximate the first and second adhesive components 104, 108, respectively.

The fibers of either ply 204 or 210 may be aligned along a reference axis. In some embodiments, the fibers may be aligned at an angle of less than about 15 degrees, less than 10 degrees, or less than 5 degrees from the first axis.

The first or second facesheet in accordance with some embodiments include at least one ply 202. In some embodiments, the first and second facesheet may include four or more plies, as shown in FIG. 3A. Fibers on each ply might be oriented in one direction or an angle with respect to the reference axis. Exemplary angles may include, but are not limited to, angles between 0 degrees to 90 degrees. In some embodiments, angles may include 0 degrees, 5 degrees, 10 degrees, 15 degrees, 30 degrees, 45 degrees, 60 degrees, or 90 degrees.

In some embodiments, the plies of the first or second facesheet are arranged in a sequence within the facesheet. As used herein, the term “ply sequence” refers to a stack arrangement for the plies or a ply stack of the facesheet that is repeated throughout at least a portion of the ply stack or throughout the entire ply stack. The sequence may be selected based on the desired structural properties of facesheet. For example, the plies of first facesheet may be arranged in a different ply sequence than those of the second facesheet to tailor performance.

In some embodiments, the ply stacks for the first and second facehsheet may have different numbers of plies. In some embodiments, the plies of the first and second facesheet may have different thicknesses.

In some embodiments, the ply stack of the first, the second or both may be quasi-isotropic, approximately equal in all directions within the laminate plane, exemplified by similar plies stacked in a preferred sequence, (45, 0, −45, 90)s, where the numbers are the axes of alignment, and the ‘s’means symmetric about the center line of the laminate. As discussed herein, an angles and ply sequence may be adjusted to increase or decrease properties in desirable directions, i.e., anisotropic.

The adhesive components 104, 108 may be the same or different. For example, the components 104, 108 may include the same or different materials, may include the same or different shapes and/or dimensions, may include the same materials in different shapes and/or dimensions, and the like. The adhesive components 104, 108 may each have an overall thickness ranging from 1 mil to 200 mils The adhesive components 104, 108 may each have overall lengths, widths, and/or diameters ranging from about 1 foot to about 100 feet, about 3 ft to about 30 ft, or about 2 ft to about 10 ft The adhesive components 104, 108 may each have overall footprints ranging from about 2 square feet to about 500 square feet, about 2 square feet to about 100 square feet, about 5 square feet to about 50 square feet

The adhesive components 104, 108 may comprises an adhesive material such as film adhesive with and without a carrier (such as polyester fibers, nylon fibers and glass fibers, polyimide film), paste adhesive. Exemplary adhesive materials can include, but not limited to, AF-6, AF-30, AF-555, AF-163, AF-503, AF-555, AF-501 (former AMD1092), and AF-191, available from 3M Company, FM-300, FM 300-2, FM 309-1, FM 377, and Meltbond 1515, available from Syensqo, EA 7000, EA 9690, and EA 9696, available from Henkel AG & Co., epoxy, bismaleimide and cyanate ester films and pastes, among other adhesives used in the aerospace industry. Similar materials which can be optimized for the environment, mechanical and fabrication requirements of the application can be used as an adhesive in the present disclosure.

The first and second adhesive components 104, 108 may comprise a single layer or multiple layers. For example, an adhesive component having multiple layers may have one or more layers with different cure rates.

FIG. 4A depicts an adhesive component 300 having a single layer 301. The single layer 301 may include one or more adhesive materials as discussed herein. In some embodiments, an adhesive component 300 may be utilized in combination with a ply stack including a ply 210. During curing, at least portions of the ply 210 may cure at an accelerated rate to limit and/or prevent resin bleed into the adhesive and/or the core material.

FIG. 4B depicts an adhesive component having multiple layers in accordance with some embodiments of the present disclosure. FIG. 4B depicts an adhesive component 302 comprising first adhesive layers 304 having a second adhesive layer 306 disposed between. The second adhesive layer includes a cure accelerating agent 312. Each first adhesive layer 304 may range in thickness from about 1 to about 1000 microns. In some embodiments, each first adhesive layer 304 may be at most about 500 microns. The second adhesive layer 306 may range in thickness from about 1 to about 1000 microns. In some embodiments, the second adhesive layer 306 may be at most about 500 microns. The cure accelerating agent 312 may be excluded, or substantially excluded, from the first adhesive layer 304. The second adhesive layer 306 may include the cure accelerating agent in an amount of at most 30 parts by weight per 100 parts by weight of total resin amount (30 phr). Other multiple layer adhesive components are possible. For example, an adhesive component may be a two-layer adhesive component having one first layer 304 and one second layer 306. The core material 106 may include but not limited to metallic or non-metallic honeycomb and other suitable patterns. Core materials are a vital part of the composite industry that help create products with a high strength to weight ratio. They also can improve thermal conductivity, sound insulations and fire resistance if core materials are used correctly. Core materials might include such brands as Soric Infusible Core Materials, Coremat, Nomex Honeycomb, Balkore (balsa core), Hexweb®, Rohacello, and Mycell (closed cell PVC core) and such materials as aluminum, carbon, carbon composite, PVC, polyurethane, wood, polymethacrylimide (PMI), The core material may have a thickness ranging from about 0.1 inch to about 10 inches. In some embodiments, the thickness may be about 0.5 inches to about 5 inches. In some embodiments, the thickness may be about 0.5 inches to 3 inches.

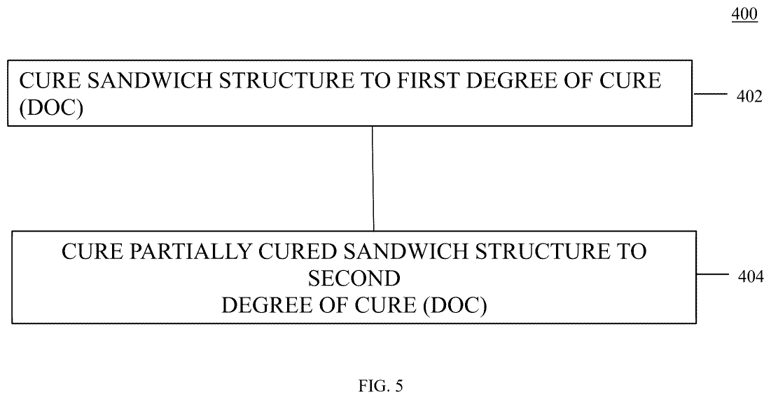

FIG. 5 depicts a flow chart of a method 400 for forming a co-cured sandwich structure in accordance with some embodiments of the disclosure. The method includes a first curing step 402 and a second curing step 404. The method 400 is described with respect to the sandwich structure 100 and embodiments depicted in FIGS. 2, 3A to 3C, and 4A to 4B. The sandwich structure 100 may be constructed using any combination of embodiments as shown in FIGS. 3A to 3C and 4A to 4B. The first and second facesheet components 102, 110 may, independently, comprise ply stacks having plies 204, plies 210, or combination thereof. The first and second adhesive components 104, 108 may independently comprise a single layer or multiple layers. The plies and the adhesive components are selected to promote a difference, during the first curing step 402, in cure rate or degree of cure (DOC) and/or flow index or viscosity (e.g. minimum viscosity, viscosity at a specific temperature and/or time during curing) between the resin composition of the plies and the adhesive component. The difference may range from about 1% to about 300%. In some embodiments, the difference may range from about 1% to at least about 5%, or at least about 2%, or at least about 3%, or at least about 20%, or at least about 50%, or at most about 100%, or about 10% to about 300%. A larger difference allows for a larger processing window to minimize or prevent the resin composition and/or adhesive component to flow into the core material 106 and ply waviness.

The method 400 includes curing the sandwich structure 100 by applying a set temperature profile 504 (depicted in FIG. 5 and described below) having a first cure segment 402 and a second cure segment 404. At 402, the sandwich structure 100 may be partially cured by applying the first cure segment 402, where during the first cure segment 402, the individual components (e.g., facesheet components, adhesive components) of the sandwich structure 100 reach individual first degrees of cure (DOC). The first and second facesheet components 102, 110 may be cured to a first facesheet DOC. The first and second adhesive components may be cured to a first adhesive DOC. After curing to the first facesheet DOC and the first adhesive DOC, the sandwich structure is in a partially cured state, where the facesheet components 102, 110 and the adhesive components 104, 108 are in partially cured states. The first facesheet DOC and the first adhesive DOC at the end of the first curing 402 are needed prior to the second curing step 404 to ensure pre-consolidation of the sandwich structure 100 to minimize or eliminate voids formation in the facesheet and/or adhesive components, resin and/or adhesive bleed into the core component, and ply waviness during and at the end of 404. The first facesheet DOC may be unequal to the first adhesive DOC. In some embodiments, the first facesheet DOC is higher than the first adhesive DOC. In some embodiments, in the partially cured state, at least one ply of at least one of the first or second facesheet components 102, 110 may have a greater first facesheet DOC than the first adhesive DOC of at least one of the first or second adhesive components 104, 108. In some embodiments, in the partially cured state, at least one ply of at least one of the first or second facesheet components 102, 110 may have a lesser first facesheet DOC than the first adhesive DOC of at least one of the first or second adhesive components 104, 108.

In some embodiments, in the partially cured state, the second region 216 of the ply 210 may have a greater first facesheet DOC than that of the first regions 214. For example, in the partially cured state, the second adhesive layer 306 may have a greater first adhesive DOC than the first adhesive DOC of the first adhesive layers 304 in the adhesive component 302. The higher rate of curing in the second region 216 and/or the second adhesive layer 306 may cause the resin in these regions to gel and cure at a faster rate. The partial cure at 402 may reduce resin flow past the adhesive component and into the core component 106. Moreover, resin in the first region 214 proximate to the adhesive component 104,108, which cures at a slower rate than the second region 216, may have sufficient time to interpenetrate into the adhesive components 104, 108 to form bonds between the facesheet components and the adhesive components.

The first facesheet DOC may range from about 20% to less than about 60%. In some embodiments, the first facesheet DOC may be about 30% to about 50%, at least about 30%, or about 35% to about 45%, or greater than about 40% to about 50%. The first adhesive DOC may be lower or higher that the first facesheet DOC as long as the DOC difference between the resin composition of the facesheet and the adhesive component may range from about 1% to at least about 5%, at least about 2%, or at least about 3%, or at least 10%, at least 20%, at least 50% during 402 and/or at the end of 402. In some embodiments, when the ply 210 is utilized in the sandwich structure 100, the first facesheet DOC for the first regions 214 may range from 20% to less than about 60%, about 30% to about 50%, at least about 30%, or about 35% to about 45%, or greater than about 40% to about 50% while the first facesheet DOC for the second region 216 may be higher than the first regions as long as the DOC difference between the first and second regions may be about 1% to at least about 5%, at least about 2%, or at least about 3%, or at least 10%, at least 20%, at least 50% during 402 and/or at the end of 402. In some embodiments, when the adhesive component 302 is utilized in the sandwich structure, the first adhesive DOC for the first adhesive layers 304 may range from 20% to less than about 60%, about 30% to about 50%, at least about 30%, or about 35% to about 45%, or greater than about 40% to about 50% while the first adhesive DOC for the second adhesive layer 306 may be higher than the first adhesive layers as long as the DOC difference between the first and second adhesive layers may be about 1% to at least about 5%, at least about 2%, or at least about 3%, or at least 10%, at least 20%, at least 50% during 402 and/or at the end of 402.

During the first cure segment 402, the method 400 may further include applying a pressure to the sandwich structure 100. The applied pressure and magnitude of pressure may be up to about 100 psi, or about 20 psi to about 100 psi. The applied pressure may minimize or prevent waviness in the plies 202 that are pressed against the core component 106 by the applied pressure during the first cure segment 402. However, an excess applied pressure may crush the core during curing. For example, pressure may be applied in an autoclave or similar cure equipment such as an oven or vacuum bag only, a press, a RapidClave® or press-clave. In some embodiments, the pressure may be applied when the desired difference between the first facesheet DOC and the first adhesive DOC is achieved and at least one of the first facesheet DOC or the first adhesive DOC reaches at most about 45%.

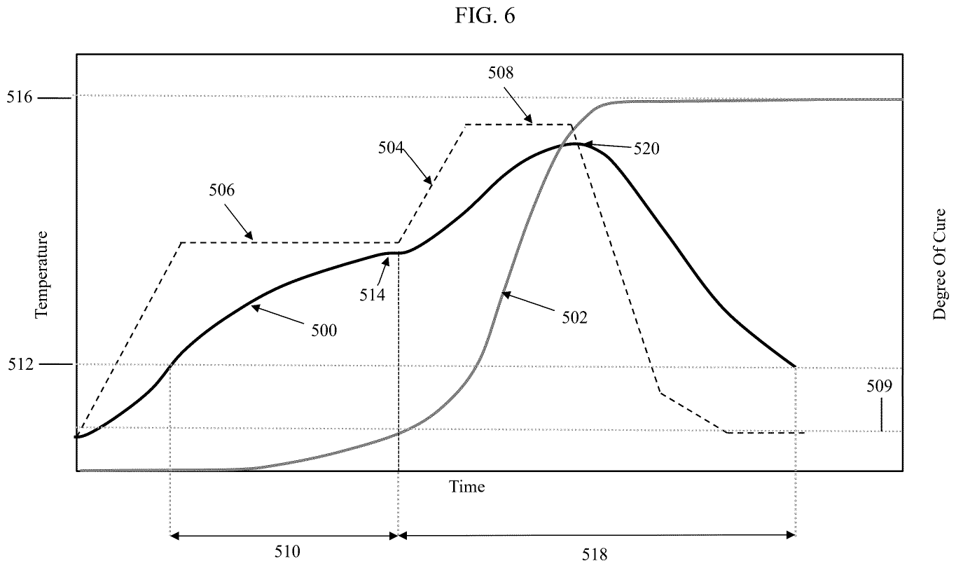

FIG. 6 depicts a schematic cure profile, wherein the set temperature profile 504 of an autoclave results in a temperature profile 500 and corresponding material state 502 (e.g., Degree of Cure (DOC)) of a component (e.g., the first and second facesheet components 102, 110 or the first and second adhesive components 104, 108) of the sandwich structure 100 in accordance with some embodiments of the disclosure. An air temperature profile (not shown) may be tracing the set temperature profile 504 and a tool temperature profile (not shown) may be lagging the set temperature profile 504. In some embodiments, the set temperature profile 504 may include a first dwell 506 and a second dwell 508 to achieve the desired first DOC and a desired second DOC, respectively, in the sandwich structure 100. As shown in FIG. 6, the first and second dwells 506, 508 include portions where the temperature may be held constant, the temperature of the second dwell 508 being higher than that of the first dwell 506. The set temperature profile 504 is determined during process development to achieve the corresponding material state 502 as described herein. Although depicted in FIG. 6 at temperatures below the set temperature profile 504, in case of exotherm or runaway reaction, the temperatures of temperature profile 500 may exceed the temperatures of the set temperature profile 504 during the first and/or second dwells 506, 508.

Curing the component of the sandwich structure 100 to a first DOC 509 may begin applying the set temperature profile 504 resulting in a temperature profile 500 of the component, during which the component remains above a threshold temperature 512 for a first elapsed time 510 and reaches a first critical temperature 514. The first critical temperature 514 may be greater than the threshold temperature 512. The component of the sandwich structure 100 may be heated above the threshold temperature 512 for the first elapsed time 510 during which the component of the sandwich structure 100 reaches the first critical temperature 514.

The multiple components (e.g., facesheet components 102,100 and adhesive components 104, 108) are cured simultaneous. Each component has an individual temperature profile 500 and corresponding material state 502 resulting from the set temperature profile 504 (only one temperature profile 500 and material state 502 are depicted in FIG. 6 for ease of explanation), and the individual temperature profile may differ based on shape of the component, position within an autoclave, airflow in the autoclave, tool material and thickness, material of the component, and the like. For example, the set temperature profile 504 may result in the facesheet components 102, 110 and the adhesive components 104, 108 reaching different first critical temperatures over the first elapsed time. For example, the set temperature profile 504 may result in the first and second facesheet components 102, 110 reaching different first critical temperatures over the first elapsed time. For example, the set temperature profile 504 may result in the first and second adhesive components 104, 108 reaching different first critical temperatures over the first elapsed time. The set temperature profile 504 is determined to promote a difference, during the first cure segment, in cure rate or degree of cure (DOC) and/or flow index or viscosity (e.g. minimum viscosity, viscosity at a specific temperature and/or time during curing) between the resin composition of the facesheet and the adhesive component, and to achieve the desired first and second DOC of the facesheet and adhesive components. The difference may range from about 1% to at least about 5%, at least about 2%, or at least about 3%, or at least 10%, at least 20%, at least 50%.

The first critical temperature may range from about 200° F. to about 330° F. for a resin composition comprising an epoxy resin whereas about 200° F. to 350° F. for a BMI resin. The first elapsed time may range from about 1 hour to about 10 hours or even longer, depending on the thickness of the sandwich structure The threshold temperature may range from 90° F. to 175° F. In some embodiments, the first critical temperature may be the maximum temperature achieved during the first dwell 506.

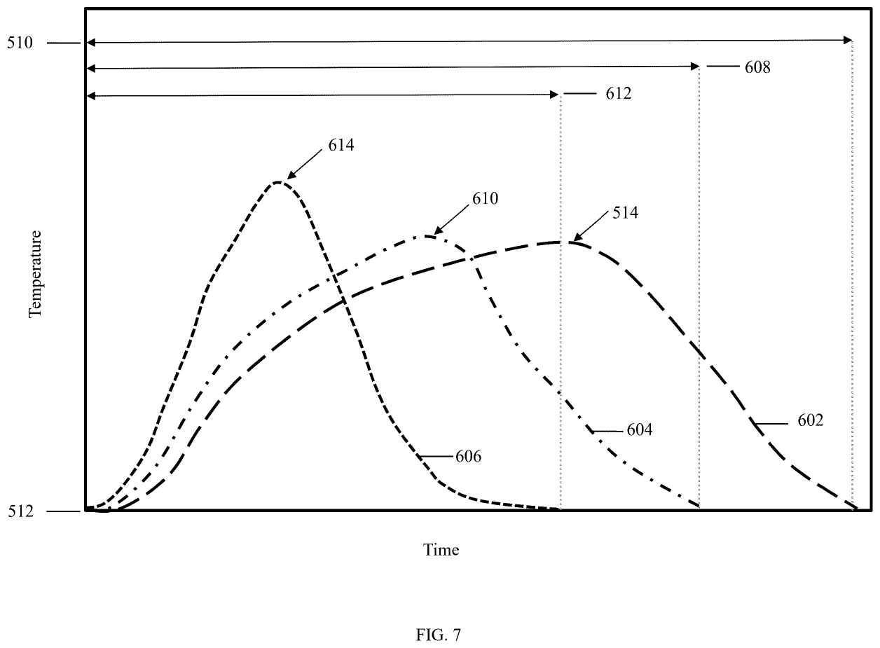

The first critical temperature and the first elapsed time are determined to produce the first DOC 509 in the component of the sandwich structure 100. For example, as shown in FIG. 6, there can be numerous permutations of temperature and elapsed time that can be used to cure the component of the sandwich structure to the first DOC 509. Exemplary cure profiles used to achieve a first DOC 509 in the component during curing at 402 are depicted in FIG. 7. Temperature profiles 602, 604, and 606 result in the same first DOC 509 of the component by different combinations of elapsed time and critical temperature. For example, temperature profile 602 has the elapsed time 510, where the elapsed time 510 is the time the sandwich structure 100 spends above the threshold temperature 512 (the x-axis in FIG. 6). During the elapsed time 510, the sandwich structure 100 reaches the first critical temperature 514. In comparison, temperature profile 604 has an elapsed time 608 and reaches a critical temperature 610, where the elapsed time 608 is shorter than elapsed time 510 and the critical temperature 610 is higher than the critical temperature 514. Temperature profile 606 has elapsed time 612 which is shorter than either of elapsed times 510, 608 and reaches a critical temperature 614 that is higher than either of critical temperatures 514, 610. Each of the temperature profiles 602, 604, and 606 can result in the component of the sandwich structure having the same first DOC 509 at the conclusion of the respective elapsed times 510, 608, and 612.

A DOC process correlation may determine a relationship between DOC in the component of the sandwich structure and temperature and elapsed time. The first critical temperature 514 and the first elapsed time 510 may be determined based on the DOC process correlation to produce the first DOC 509 in the component of the sandwich structure 100.

The DOC process correlation may be determined from at least one of a calibration curve having a functional relation between DOC and temperature and time, a lookup table having paired values of the first critical temperature 514 and the first elapsed time 510 that produce the first target DOC 509, a semi-empirical DOC model of the sandwich structure 100, a plurality of DOC simulations of the sandwich structure 100 for a plurality of DOC distinct process conditions, wherein the DOC simulations include thermal chemical models, or experimental measurement.

A semi-empirical DOC model may be utilized to determine the degree of cure evolution as a function of temperature, time and geometry. The semi-empirical model may include an equation describing a physics-based relationship among cure rate, temperature and time. Depending on materials, the coefficients and terms might be different. The model may include density, specific heat capacity, thermal conductivity, and heat of reaction. Additional relevant parameters of the model may include but not limited to rate of conversion, activation energy, rate constant, glass transition temperature, pre-exponential factor (Arrhenius rate constant), gas constant, Di-Benedetto parameter (a parameter controlling the convexity of the evolution curve), heat transfer coefficient, and diffusion kinetics.

The DOC simulation may include thermal chemical models. Examples of commercial software packages include RAVEN and COMPRO available from Convergent Manufacturing Technologies. The plurality of DOC distinct process conditions includes at least one of a plurality of different heated environment temperatures utilized during heating the sandwich structure 100 providing different heat transfer coefficients between the heated environment and the sandwich structure 100, a plurality of different heating rates for the sandwich structure 100, a plurality of different materials and thicknesses for the sandwich structure 100, a plurality of different materials, thicknesses, thermal conductivity, heat capacity and density for tooling.

Experimental measurement may include, for example, curing a plurality of a sandwich structures 100, each to different times and/or temperatures of interest, removing one or more samples of each component (e.g., facesheet 102, 110 and adhesive components 104, 108) at one or more locations of interest, and analyzing the one or more samples via differential scanning calorimetry (DSC) to obtain a DOC of the one or more samples. From an analysis of the plurality of sandwich structure 100, an evolution of DOC as a function of time and temperature can be determined for each component. Temperature profiles may be developed based on the experimental measurements. Because of the trial-and-error nature of this experimental process, simulation-based process optimization may be more preferred to track and monitor evolution of DOC(s). In contrast, the current state of the art baseline is to obtain the local DOC(s) by DSC measurement at the end of the cure rather than during the cure to avoid cure disruptions resulting in a poor quality of the sandwich structure. Thus, evolution of DOC is not determined in the current state of the art.

During curing at 402 (and at 404 discussed below), the sandwich structure 100 can be monitored at a number of locations using temperature sensors. There may be variation in temperature at one or more of the locations being monitored. For example, variation could be due to, but not limited to, shape of the part, thickness, materials being cured, cure equipment, tool and/or combinations. For example, cure equipment may be equipment used to cure the sandwich structure 100, such as autoclave, oven, press, and the like. For example, tool may be equipment used to shape or form the sandwich structure then the sandwich structure may be cured on the tool when placed in cure equipment, such as a mandrel to lay up plies for a part. For example, different locations on the sandwich structure could reach the threshold temperature or the first critical temperature at different times. The first elapsed time at each location may begin and end at different times at each location. Some locations might reach the first critical temperature (i.e., leading locations) and some might not (i.e., lagging locations). Thus, based on the monitored temperatures at each location of the sandwich structure, it must be decided, for example, when to end curing at 402. In some embodiments, a select location (e.g., on a component, such as a facesheet component or adhesive component) could be monitored, and the curing at 402 could be ended based on the temperature monitored at the selected location. In some embodiments, an average of the temperatures from all locations (e.g., on one or more components) can be determined, and the curing at 402 could be ended based on the average temperature at all the locations being monitored. In some embodiments, the lowest and the highest temperature measured at all the locations can be determined, and the curing at 402 could be ended based on when the resulting lowest and highest first DOCs reach a desired cured state range and/or a desired averaged value of the lowest and highest first DOCs.

In some embodiments, an average value of the first DOC (i.e., at all locations on a component) may be less than 60%. In some embodiments, an averaged first DOC value at all locations on the part or of the lowest and highest first DOCs may be about 20% to less than about 60%, about 30% to about 50%, at least about 30%, or about 35% to about 45%, or greater than about 40% to about 50%. In some embodiments, the above-mentioned methods to determine the first DOC of each of the components of the sandwich construction 100 at the end of the first curing step 402 may be applied to determine an instantaneous DOC of the component at a given temperature and time to establish the DOC difference between the resin composition of the facesheet and the adhesive component.

Prior to production, to determine a target first DOC of a component (e.g., the first facesheet component) of the sandwich structure 100, a DOC process correlation may be utilized to determine an elapsed time and a critical temperature that would be needed to produce the target first DOC (e.g., DOC 509) . For example, the DOC process correlation of the first facesheet component may be used to select a target first facesheet DOC (e.g., DOC 509). Then, the elapsed time (e.g., elapsed time 510), critical temperature (e.g., critical temperature 514) needed to produce the target first facesheet DOC may be considered in the DOC process correlation of the first adhesive component to determine a target first adhesive DOC that results from that elapsed time and critical temperature. If the target first facesheet DOC that the elapsed time and critical temperature would produce in the first facesheet component is not desired, then a different DOC may be selected such that a desired combination of the target first facesheet DOC and the first adhesive DOC, providing a desired DOC difference, is achieved during and at the end of 402. In addition, the selected elapsed time and critical temperature may further be considered in determining viscosity of one of a resin composition of the first facesheet component and the first adhesive component providing a desired viscosity difference. The desired combination of first facesheet DOC and first adhesive DOC at the end of 402 and pressure are selected to produce, as described herein, a desired level of pre-consolidation of the sandwich structure 100, which at the end of 402, as described herein, produces a desired sandwich structure 100 with minimal defects such as voids in the facesheet resin bleed into the core, ply wrinkles and ply waviness.

In some embodiments, viscosity of one of a resin composition of the facesheet component and the adhesive component can be determined by a viscosity process correlation or experiments. A viscosity process correlation determines a relationship between the viscosity of one of the resin composition of the facesheet component and the adhesive component of the sandwich structure and temperature and elapsed time. The first critical temperature 514 and the first elapsed time 510 may be determined based on the viscosity process correlation to produce the viscosity of the components of the sandwich structure 100.

The viscosity process correlation is determined by at least one of a semi-empirical viscosity model, a plurality of viscosity simulations for a plurality of viscosity distinct process conditions, or experimental measurement. A semi-empirical viscosity model may be a function of degree of cure at gelation, pressure, bulk modulus, temperature, Arrhenius constant, gas constant and other relevant parameters and constants. For example, an Arrhenius type relation activated by temperature and degree of cure, which was proposed by Lee, Loos and Springer to model viscosity of Hercules 3501-6 epoxy resin and modified by Convergent to include a maximum viscosity value. The predicted viscosity is not applicable beyond gelation.

The viscosity simulations may be part of the flow-compaction simulation outputs/models but also dependent on thermo-chemical models. The flow of resin and movement of the composite structure depend on pressure, temperatures, and boundary conditions. Examples of commercial software packages include RAVEN and COMPRO available from Convergent Manufacturing Technologies. The plurality of viscosity distinct process conditions includes at least one of a plurality of different heated environment temperatures utilized during heating the sandwich structure providing different heat transfer coefficients between the heated environment and the sandwich structure, a plurality of different heating rates for the sandwich structure, a plurality of different materials and thicknesses for the components of the sandwich structure, or a plurality of different materials, thicknesses, thermal conductivity, heat capacity and density for the tool.

Experimental measure may include rheology testing may be conducted to assess the deformation and/or flow of a material on the influence of imposed stresses. Rheology tests may include frequency sweeps, temperature ramps, profile-based, intrinsic viscosity and relative viscosity, capillary rheometry or suitable/applicable method. For example, a shear force may be applied to a sample (e.g., epoxy resin) at a given temperature and the corresponding output, e.g., flow behavior, is measured. These tests may be conducted on different materials at different temperatures. Tests may be performed on same materials that have different initial degree of cure.

In some embodiments defects such as resin and/or adhesive bleed into the core, ply wrinkles, void in the facesheet component, ply waviness of the sandwich structure 100 at the end of 404 as described herein can be determined by a defect process correlation or experiments. A defect process correlation determines a relationship between the defect of the components of the sandwich structure and temperature and elapsed time, provided the desired material states at the end of 402 are met. The second critical temperature 520 and the second elapsed time 518 are selected based on the DOC process correlation and defect process correlation to produce the target second DOC and the target defect in the components of the sandwich structure at the end of 404.

The defect process correlation is determined by at least one of a semi-empirical defect model of the components of the sandwich structure, a plurality of defect simulations for a plurality of defect distinct process conditions, or experimental measurement.

A semi-empirical defect model may include a generalized empirical equation that enables the prediction of defect. The purpose of the defect model is to predict defect for a given cure cycle (time, temperature, ramp rates and/or pressure). Parameters of the model may include empirical constants and parameters describing thermal, chemical and/or mechanical behavior of material makeup of the components of the sandwich structure during curing.

The defect simulations include thermal-chemical and fiber-bed compaction models. Examples of commercial software packages include RAVEN and COMPRO available from Convergent Manufacturing Technologies. The plurality of defect distinct process conditions includes at least one of a plurality of different heated environment temperatures utilized during heating the sandwich structure providing different heat transfer coefficients between the heated environment and the sandwich structure, a plurality of different heating rates for the sandwich structure, a plurality of different pressures for the sandwich structure, a plurality of different materials and thicknesses for the components of the sandwich structure, or a plurality of different materials, thicknesses, thermal conductivity, heat capacity and density for the tool.

Experimental measure may include X-ray computed tomography, ultrasonic or visual, thermography, micrographs of cross-sections, their derivatives, the alike or the similar.

Returning to FIG. 5, at cure segment 404, the partially cured sandwich structure 100 is further cured. The sandwich structure may be further cured such that the first and second facesheet components 102, 110 may be cured to a second facesheet DOC that is greater than the first facesheet DOC, and the first and second adhesive components 104,108 may be cured to a second adhesive DOC that is greater than the first adhesive DOC. In some embodiments, the second facesheet DOC and the second adhesive DOC may be the final state of the facesheet and adhesive components, respectively. Alternatively, additionally curing steps after 404 may be used to obtain a final cured states.

Returning to FIG. 6, the partially cured component (e.g., facesheet component or adhesive component) of the sandwich structure 100 is cured to a second degree of cure (DOC) 516 (e.g., second facesheet DOC or second adhesive DOC) beginning after the component has reached the first DOC 509. Transition from 402 to 404 might happen once either one of the facesheet components or one of the adhesive components reaches the first DOC 509 of about 40% or about 35% to about 50%, providing the cured sandwich structure has a desired void content in the facesheet and/or adhesive components, resin and/or adhesive bleed into the core component, and ply waviness during and at the end of 404. In some embodiments, transition from 402 to 404 might happen once both of the facesheets or both of the adhesive components reach the first DOC 509 of about 40% or about 35% to about 50%, providing the cured sandwich structure has a desired void content in the facesheet and/or adhesive components, resin and/or adhesive bleed into the core component, and ply waviness during and at the end of 404. The second DOC 516 is greater than the first DOC 509. The second DOC may range from greater than about 60% to greater than about 90%. In some embodiments, the second DOC may range from about 70% to about 99%, or about 80% to about 99%, or at least about 90%, or about 90% to about 99%.

Curing the component of the sandwich structure 100 to the second DOC 516 may begin by determining a second elapsed time 518 that the partially cured component of the sandwich structure 100 should remain above the first critical temperature 514 and determining a second critical temperature 520 that the partially cured component of the sandwich structure 100 should reach during the second elapsed time 518. The second critical temperature 520 may be greater than the first critical temperature 514. After determining of the second elapsed time 518 and the second critical temperature 520, the partially cured component of the sandwich structure 100 may be heated above the first critical temperature 514 for the second elapsed time 518 during which the component of the sandwich structure 100 reach the second critical temperature 520.

The second elapsed time may range from about 1 hour to 10 hours, depending thickness of the sandwich structure. The second critical temperature may range from about 300° F. to about 375° F. for a resin composition comprising an epoxy resin while the second critical temperature might range from about 350° F. to about 500° F. for a BMI resin.

The second critical temperature 520 and the second elapsed time 518 are determined to produce the second DOC 516 in the component of the partially cured sandwich structure 100. Similar to the first DOC 509, there can be numerous permutations of temperature and elapsed time that can be used to cure the partially cured component of the sandwich structure 100 to the second DOC 516. In some embodiments, the second critical temperature 520 may be the maximum temperature achieved during the second dwell 508.

The second critical temperature 520 and the second elapsed time 518 are determined to produce the second DOC in the partially cured component of the sandwich structure 100. A process correlation may determine a relationship between DOC in the component of the sandwich structure 100, and temperature and elapsed time. The second critical temperature 520 and the second elapsed time 518 may be determined based on the DOC process correlation to produce the second DOC 516 in the partially cured component of the sandwich structure 100. The process correlation discussed herein to produce the first DOC 509 may be utilized to produce the second DOC 516 in the same manner.

After the curing at 404 to the second DOC 516, the cured sandwich structure may have one of (1) a void content in the facesheet and/or adhesive components less than 5% or a total void percentage based on the total measured/scanned area/volume of interest, (2) resin and/or adhesive bleed into the core component less than 30% of the total amount of either resin, adhesive or both, (3) ply wrinkles less than 30%, and (4) ply waviness less than 50%. The defect may not be uniform throughout the sandwich structure, for example, because of facets, corners, and/or non-uniform shape of the sandwich structure. For example, the overall defect may be less than the desired value and some localized regions of interest of the sandwich structure may have more than the desired value void. In some embodiments, after the curing at 404 to the second DOC 516, the cured sandwich structure may have one of (1) a void content in the facesheet and/or adhesive components less than 2%, (2) resin and/or adhesive bleed into the core component less than 10%, (3) ply wrinkles less than 10%, and (4) ply waviness less than 20%.

In an exemplary embodiment of the present disclosure, a method of co-curing a sandwich structure comprises providing a sandwich structure comprises, in order, a first facesheet component; ma first adhesive component; a core component; a second adhesive component; and a second facesheet component; curing the first and second facesheet components to a first facesheet degree of cure (DOC) and curing the first and second adhesive components to a first adhesive DOC, wherein the first facesheet DOC and the first adhesive DOC being a partially cured states, and wherein the first facesheet DOC is unequal to the first adhesive DOC; and curing the partially cured first and second facesheet components to a second facesheet DOC and curing the partially cured first and second adhesive components to a second adhesive DOC, wherein the second facesheet DOC being greater than the first facesheet DOC and the second adhesive DOC being greater than the first adhesive DOC.

The method of the immediately preceding paragraph, wherein wherein the first facesheet DOC is higher than the first adhesive DOC, and wherein a difference between the first facesheet DOC and the first adhesive DOC is at least 3%.

The method of any of the two preceding paragraphs, wherein each of the first facesheet component and the second facesheet component comprise a plural of plies.

The method of any of the three preceding paragraphs, wherein at least one ply in each of the first and second facesheet components has first regions and a second region between the first regions, wherein the first regions cure at a slower rate than the second region.

The method of any of the four preceding paragraphs, wherein the second region include a cure accelerating agent, and wherein the cure accelerating agent is absent from the first regions.

The method of any of the five preceding paragraphs, wherein each ply in the plurality of plies includes a composite material, wherein the composite material includes a thermoset resin, a curing agent, a cure accelerating agent, and one or more structural members, and wherein the one or more structural members is one or more fibers.

The method of any of the six preceding paragraphs, wherein, in the at least one ply, the second region includes the one or more structural members.

The method of any of the seven preceding paragraphs, wherein the first adhesive DOC is higher than the first facesheet DOC, wherein a difference between the first adhesive DOC and the first facesheet DOC is at least 3%.

The method of any of the eight preceding paragraphs, wherein each of the first and second adhesive components further comprises first adhesive regions and a second adhesive region in between the first adhesive regions, wherein the first adhesive region cures at a slower rate than the second adhesive region.

The method of any of the nine preceding paragraphs, wherein the first adhesive region is closer to the core component than the second adhesive region.

The method of any of the ten preceding paragraphs, wherein the second adhesive region includes a cure accelerating agent that is absent from the first adhesive region.

The method of any of the eleven preceding paragraphs, wherein curing the sandwich structure to the first facesheet DOC and first adhesive DOC further comprises applying a first cure segment of a set temperature profile, wherein, during the first cure segment, the first and second facesheet components remains above a threshold temperature for a first elapsed time and reach a first critical temperature during the first elapsed time, and wherein the first and second adhesive components remain above a threshold temperature for the first elapsed time and reach a first critical temperature during the first elapsed time, and wherein the first critical temperature of the first and second facesheet components and the first critical temperature of the first and second adhesive components are different.

The method of any of the twelve preceding paragraphs, wherein applying the first cure profile further comprises monitoring an actual temperature, individually, at each of the first facesheet component, the second facesheet component, the first adhesive component, and the second adhesive component during heating of the sandwich structure; and comparing the actual temperature to the first critical temperature of the monitored component, wherein if the actual temperature is below the first critical temperature of the monitored component, adjusting one or more conditions to achieve the first critical temperature of the monitored component.

The method of any of the thirteen preceding paragraphs, wherein monitoring the actual temperature, individually, at each of the first facesheet component, the second facesheet component, the first adhesive component, and the second adhesive component during the heating of the sandwich structure includes at least one of (i) monitoring a select temperature at a select location on of each of the first facesheet component, the second facesheet component, the first adhesive component, and the second adhesive component; (ii) monitoring an average temperature of each of the first facesheet component, the second facesheet component, the first adhesive component, and the second adhesive component; or (iii) monitoring a leading and lagging temperature-response location of each of the first facesheet component, the second facesheet component, the first adhesive component, and the second adhesive component.

The method of any of the fourteen preceding paragraphs, wherein the monitoring the actual temperature, individually, at each of the first facesheet component, the second facesheet component, the first adhesive component, and the second adhesive component during the heating of the sandwich structure includes monitoring a plurality of temperatures of each of the first facesheet component, the second facesheet component, the first adhesive component, and the second adhesive component at a plurality of spaced-apart locations on each of the first facesheet component, the second facesheet component, the first adhesive component, and the second adhesive component.

The method of any of the fifteen preceding paragraphs, wherein during the first cure segment, the method further comprises applying a critical pressure when a difference between the first facesheet DOC and the first adhesive DOC is at least about 2% and at least one of the first facesheet DOC or the first adhesive DOC reaches at most about 45%.

The method of any of the sixteen preceding paragraphs, wherein the first critical temperature of the first and second facesheet components, the first critical temperature of the first and second adhesive components, and the first elapsed time are determined to produce the first facesheet DOC and the first adhesive DOC.

The method of any of the seventeen preceding paragraphs, wherein a DOC process correlation determines a relationship between DOC in the first and second facesheet components and in the first and second adhesive components, and temperature and time,

wherein the first critical temperature of the first and second facesheet components, the first critical temperature of the first and second adhesive components, and the first elapsed time are further determined based on the DOC process correlation to produce the first facesheet DOC and the first adhesive DOC.

The method of any of the eighteen preceding paragraphs, the DOC process correlation is determined from at least one of: (i) a calibration curve having a functional relation between the first facesheet DOC and a first critical temperature of each of the first and second facesheet components and the first elapsed time, or between the first adhesive DOC and a first critical temperature of each of the first and second adhesive components and the first elapsed time; (ii) a lookup table having paired values of the first critical temperature of each of the first and second facesheet components and the first elapsed time that produce the first facesheet DOC, or of the first critical temperature of each of the first and second adhesive components and the first elapsed time that produce the first adhesive DOC; (iii) a semi-empirical DOC model of each of the first and second facesheet components, or of each of the first and second adhesive components; (iv) a plurality of DOC simulations of each of the first and second facesheet components, or of each of the first and the second adhesive components, for a plurality of DOC distinct process conditions, wherein the DOC simulations include thermal chemical models; or (v) an experimental measurement.

The method of any of the nineteen preceding paragraphs, wherein the plurality of DOC distinct process conditions includes at least one of (i) a plurality of different heated environment temperatures utilized during heating the sandwich structure providing different heat transfer coefficients between at least the heated environment and the sandwich structure; (ii) a plurality of different heating rates for the sandwich structure; (iii) a plurality of different materials and thicknesses for each of the first and second facesheet components and each of the first and second adhesive components; and (iv) a plurality of different materials, thicknesses, thermal conductivity, heat capacity and density for tooling.

The method of any of the twenty preceding paragraphs, further comprises applying a second cure segment of the set temperature profile, wherein, during the second cure segment, the first and second facesheet components remains above the threshold temperature for a second elapsed time and reach a second critical temperature during the second elapsed time, and wherein the first and second adhesive components remain above the threshold temperature for the second elapsed time and reach a second critical temperature during the second elapsed time, and wherein the second critical temperature of the first and second facesheet components and the second critical temperature of the first and second adhesive components are different.

The method of any of the twenty-one preceding paragraphs, wherein the second critical temperature of the first and second facesheet components, the second critical temperature of the first and second adhesive components, and the second elapsed time are selected to produce the second facesheet DOC and the second adhesive DOC.

In an exemplary embodiment of the present disclosure, a sandwich structure, comprising, in order, a first facesheet component; a first adhesive component; a core component; a second adhesive component; and a second facesheet component, wherein each of the first and second facesheet components is curable at an inequal rate to each of the first and the second adhesive components.

The sandwich structure of the immediately preceding paragraph, wherein at least one of the first or second facesheet components comprise a plurality of plies, wherein each ply in the plurality of plies includes one or more structural members, and wherein the one or more structural members is one or more fibers, or at least one of the first or second adhesive component comprising more than one layers, wherein at least one ply or one layer has first regions and a second region in between the first regions, wherein the second region is curable at a faster rate than the first region.

The sandwich structure of any of the two preceding paragraphs, wherein the second region includes a cure accelerating agent, wherein the cure accelerating agent is absent from the first regions.

The sandwich structure of any of the three preceding paragraphs, wherein each of the first and second facesheet components comprise a plurality of plies, wherein each ply in the plurality of plies includes one or more structural members, and wherein the one or more structural members is one or more fibers.

The sandwich structure of any of the four preceding paragraphs, wherein at least one ply includes the first regions and the second region, wherein the second region includes the one or more structural members.

The sandwich structure of any of the five preceding paragraphs, wherein each of the first and second adhesive components comprises the first regions and the second adhesive region in between the first regions.

The sandwich structure of any of the six preceding paragraphs, wherein the second region includes a cure accelerating agent.

The sandwich structure of any of the seven preceding paragraphs, wherein the cure accelerating agent is absent from the first region.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended statements to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method of co-curing a sandwich structure, comprising:
providing a sandwich structure comprises, in order:
a first facesheet component;
a first adhesive component;
a core component;
a second adhesive component; and
a second facesheet component;
curing the first and second facesheet components to a first facesheet degree of cure (DOC) and curing the first and second adhesive components to a first adhesive DOC, wherein the first facesheet DOC and the first adhesive DOC being a partially cured states, and wherein the first facesheet DOC is unequal to the first adhesive DOC; and
curing the partially cured first and second facesheet components to a second facesheet DOC and curing the partially cured first and second adhesive components to a second adhesive DOC, wherein the second facesheet DOC being greater than the first facesheet DOC and the second adhesive DOC being greater than the first adhesive DOC.

2. The method of claim 1, wherein the first facesheet DOC is higher than the first adhesive DOC, and wherein a difference between the first facesheet DOC and the first adhesive DOC is at least 3%.

3. The method of claim 2, wherein each of the first facesheet component and the second facesheet component comprise a plural of plies.

4. The method of claim 3, wherein at least one ply in each of the first and second facesheet components has first regions and a second region between the first regions, wherein the first regions cure at a slower rate than the second region.

5. The method of claim 4, wherein the second region include a cure accelerating agent, and wherein the cure accelerating agent is absent from the first regions.

6. The method of claim 5, wherein each ply in the plurality of plies includes a composite material, wherein the composite material includes a thermoset resin, a curing agent, a cure accelerating agent, and one or more structural members, and wherein the one or more structural members is one or more fibers.

7. The method of claim 6, wherein, in the at least one ply, the second region includes the one or more structural members.

8. The method of claim 1, wherein the first adhesive DOC is higher than the first facesheet DOC, wherein a difference between the first adhesive DOC and the first facesheet DOC is at least 3%.

9. The method of claim 8, wherein each of the first and second adhesive components further comprises first adhesive regions and a second adhesive region in between the first adhesive regions, wherein the first adhesive region cures at a slower rate than the second adhesive region.

10. The method of claim 9, wherein the first adhesive region is closer to the core component than the second adhesive region.

11. The method of claim 10, wherein the second adhesive region includes a cure accelerating agent that is absent from the first adhesive region.

12. The method of claim 1, wherein curing the sandwich structure to the first facesheet DOC and first adhesive DOC further comprises:
applying a first cure segment of a set temperature profile, wherein, during the first cure segment, the first and second facesheet components remains above a threshold temperature for a first elapsed time and reach a first critical temperature during the first elapsed time, and wherein the first and second adhesive components remain above a threshold temperature for the first elapsed time and reach a first critical temperature during the first elapsed time, and wherein the first critical temperature of the first and second facesheet components and the first critical temperature of the first and second adhesive components are different.

13. The method of claim 12, wherein during the first cure segment, the method further comprises:
applying a critical pressure when a difference between the first facesheet DOC and the first adhesive DOC is at least about 2% and at least one of the first facesheet DOC or the first adhesive DOC reaches at most about 45%.

14. The method of claim 12, wherein the first critical temperature of the first and second facesheet components, the first critical temperature of the first and second adhesive components, and the first elapsed time are determined to produce the first facesheet DOC and the first adhesive DOC.

15. The method of claim 14, wherein a DOC process correlation determines a relationship between DOC in the first and second facesheet components and in the first and second adhesive components, and temperature and time,
wherein the first critical temperature of the first and second facesheet components, the first critical temperature of the first and second adhesive components, and the first elapsed time are further determined based on the DOC process correlation to produce the first facesheet DOC and the first adhesive DOC.

16. The method of claim 15, wherein the DOC process correlation is determined from at least one of:
(i) a calibration curve having a functional relation between the first facesheet DOC and a first critical temperature of each of the first and second facesheet components and the first elapsed time, or between the first adhesive DOC and a first critical temperature of each of the first and second adhesive components and the first elapsed time;
(ii) a lookup table having paired values of the first critical temperature of each of the first and second facesheet components and the first elapsed time that produce the first facesheet DOC, or of the first critical temperature of each of the first and second adhesive components and the first elapsed time that produce the first adhesive DOC;
(iii) a semi-empirical DOC model of each of the first and second facesheet components, or of each of the first and second adhesive components;
(iv) a plurality of DOC simulations of each of the first and second facesheet components, or of each of the first and the second adhesive components, for a plurality of DOC distinct process conditions, wherein the DOC simulations include thermal chemical models; or
(v) an experimental measurement.

17. The method of claim 16, wherein the plurality of DOC distinct process conditions includes at least one of:
(i) a plurality of different heated environment temperatures utilized during heating the sandwich structure providing different heat transfer coefficients between at least the heated environment and the sandwich structure;
(ii) a plurality of different heating rates for the sandwich structure;
(iii) a plurality of different materials and thicknesses for each of the first and second facesheet components and each of the first and second adhesive components; and
(iv) a plurality of different materials, thicknesses, thermal conductivity, heat capacity and density for tooling.

18. The method of claim 12, further comprises:
applying a second cure segment of the set temperature profile, wherein, during the second cure segment, the first and second facesheet components remains above the threshold temperature for a second elapsed time and reach a second critical temperature during the second elapsed time, and wherein the first and second adhesive components remain above the threshold temperature for the second elapsed time and reach a second critical temperature during the second elapsed time, and wherein the second critical temperature of the first and second facesheet components and the second critical temperature of the first and second adhesive components are different.

19. The method of claim 18, wherein the second critical temperature of the first and second facesheet components, the second critical temperature of the first and second adhesive components, and the second elapsed time are selected to produce the second facesheet DOC and the second adhesive DOC.

20. A sandwich structure, comprising, in order:
a first facesheet component;
a first adhesive component;
a core component;
a second adhesive component; and
a second facesheet component,
wherein each of the first and second facesheet components is curable at an inequal rate to each of the first and the second adhesive components.
